(19) United States
(12) Patent Application Publication
(10) Pub. No.: US 2012/0260654 A1
(43) Pub. Date: Oct. 18, 2012

(54) DRIVING DEVICE

(76) Inventor: Thomas Proepper, Reutlingen (DE)

(21) Appl. No.: 13/499,865

(22) PCT Filed: Sep. 21, 2010
(86) PCT No.: PCT/EP2010/063880

§ 371 Date: Jun. 26, 2012

(30) Foreign Application Priority Data
Oct. 6, 2009 (DE) 10 2009 045 380.6

(51) Int. Cl. F02B 37/10; F02B 73/00

(52) U.S. Cl. 60/607

(57) ABSTRACT

A driving device having a charging device for increasing the pressure and the mass flow of the combustion air of an internal combustion engine, and having a steam generator for evaporating a fluid using thermal energy drawn from the exhaust gas of the internal combustion engine. The steam generator is connected to a steam accumulator, and the charging device is an exhaust gas turbocharger whose drive turbine can be acted on at least partly both by exhaust gas and also by steam from the steam accumulator, the steam pressure and/or steam mass flow of the steam supplied to the exhaust gas turbocharger being capable of being regulated and/or controlled.

### FIELD OF THE INVENTION

The present invention relates to a driving device having a charging device for increasing the pressure and the mass flow of the combustion air of an internal combustion engine, and having a steam generator for evaporating a fluid using thermal energy drawn from the exhaust gas of the internal combustion engine.

### BACKGROUND INFORMATION

Such driving devices are believed to be understood from the art. For example, DE 10 2006 057 247 A1 discusses a charging device, in particular for charging an internal combustion engine. In an exhaust passage of the internal combustion engine, there is situated at least one heat exchanger of a circuit of the working medium. A conveyor aggregate is connected before the at least one exhaust gas heat exchanger in the circuit of the working medium. Here it is provided that the circuit of the working medium contains at least one turbine part via which at least one compressor part situated in the intake tract of the internal combustion engine is driven. In this way, using heat from the exhaust passage of the internal combustion engine, the charging device is operated so as to increase the pressure in the intake tract of the internal combustion engine. A similar device is discussed in GB 2 060 766 A. Also, DE 199 39 289 C1 discusses a method and a device for preparing gas mixtures.

In order to increase the effectiveness and the specific output and volumetric efficiency of internal combustion engines, charge air compression is known, for example using piston compressors or turbines. The energy required to increase the pressure and mass flow is taken from the exhaust gas of the internal combustion engine by using a steam generator to evaporate fluid using the thermal energy of the exhaust gas. In this way, at least a part of the energy of the exhaust gas flowing through an exhaust passage of the internal combustion engine can be recuperated and used to increase the efficiency of the internal combustion engine.

### SUMMARY OF THE INVENTION

In contrast, the driving device having the features described herein has the advantage that the efficiency of the internal combustion engine can be further increased in particular through an increased exploitation of the energy contained in the exhaust gas of the internal combustion engine. According to the exemplary embodiments and/or exemplary methods of the present invention, this is achieved by connecting the steam generator to a steam accumulator, and in that the charging device is an exhaust gas turbocharger whose drive turbine can be acted on at least partly both by exhaust gas and also by steam from the steam accumulator, the steam pressure and/or steam mass flow of the steam supplied to the exhaust gas turbocharger being capable of being regulated and/or controlled. The exhaust gas turbocharger is used to improve the degree of filling, or volumetric efficiency, of the internal combustion engine, and to reduce the suction work that has to be performed by this engine during an intake stroke.

In general, these measures increase the power capacity and efficiency of the internal combustion engine. The exhaust gas turbocharger standardly has at least one drive turbine and at least one air compressor, the drive turbine driving the air compressor. The driving device has an exhaust passage and a steam circuit. The exhaust gas of the internal combustion engine flows through the exhaust passage, and the produced steam or fluid is provided in the steam circuit. According to the exemplary embodiments and/or exemplary methods of the present invention, it is provided to drive the exhaust gas turbine with superheated steam and/or saturated steam in addition to the exhaust gas. The exhaust passage and the steam circuit can run completely separate from one another, but may also be connected to each other at least in some regions, so that a mixture of the steam with the exhaust gas can take place. The steam is produced by using the steam generator to evaporate the fluid, using the thermal energy contained in the exhaust gas of the internal combustion engine. Here, it is not necessary to supply all the exhaust gas and/or all the generated steam to the charging device or to the exhaust gas turbocharger.

Rather, it is advantageous if the supplied portions of the exhaust gas or steam are adjustable. It is particularly advantageous not to supply the obtained steam immediately to the exhaust gas turbocharger, but rather first to store it in the steam accumulator, in order to introduce it into the exhaust gas turbocharger in a controlled and/or regulated manner, taking into account the momentary operating state of the internal combustion engine that is to be charged. For this purpose, the driving device according to the present invention provides the steam accumulator or steam pressure accumulator (steam boiler) from which the steam is taken for acting on the exhaust gas turbocharger, for example in the form of saturated steam, or for introduction into a superheater and subsequent action on the exhaust gas turbocharger. The controlling and/or regulation can be continuous, taking place in particular as a function of an exhaust gas pressure and/or an exhaust gas mass flow.

The exhaust gas turbocharger is operated primarily with the exhaust gas of the internal combustion engine. However, the generated steam can also at least supplement this operation. This steam can be used above all for a momentary increase in the charge pressure of the exhaust gas turbocharger, thus producing a rapid increase in the rotational speed and/or torque of the internal combustion engine, independent of the rotational speed of the internal combustion engine and/or of the exhaust gas turbocharger, the charge pressure, the air mass flow to the internal combustion engine, the exhaust gas pressure, and/or the exhaust gas mass flow. The additional supplying of steam overcomes the standardly lagging response characteristic of the exhaust gas turbocharger by very quickly accelerating the drive turbine of the exhaust gas turbocharger as soon as an agile deployment of power is required. This is the case in particular given acceleration of the internal combustion engine out of the partial load range, with a high torque requirement, or in high-speed passing maneuvers if the driving device is used in a motor vehicle.

The driving device according to the present invention has the further advantage that it is capable of cooling the exhaust gas of the internal combustion engine to the desired temperature range in a regulated and/or controlled operating manner before the exhaust gas enters an exhaust gas post-treatment device. This is necessary in particular in the case of gasoline engines having exhaust gas peak temperatures greater than 1000° C. before entry into the exhaust gas post-treatment device, because the 3-way or NOₓ storage catalytic converters standardly provided as exhaust gas post-treatment devices are intended to be operated in a temperature range of optimal reduction rates, from 400° C. to 750° C. or from 300° C. to 450° C. In addition, a radiation of heat by the internal combustion engine, in particular an exhaust manifold, and by a segment of the exhaust passage close to the engine into an engine chamber is reduced. In addition, in exhaust gas turbochargers having impact charging, as used for example in slow and medium-fast-running diesel engines, the steam can be used to make uniform the acting pressure and exhaust gas mass flow of the exhaust gas turbine of the exhaust gas turbocharger. This is possible in particular in the case of exhaust gas turbochargers that receive multiple flows. In principle, two specific embodiments of the driving device according to the present invention are technically advantageous: on the one hand, an embodiment is advantageous having the form of an open steam circuit in which the steam is introduced into the exhaust gas flow upstream from the exhaust gas turbocharger and the exhaust gas/steam mixture acts on a single turbine wheel in order to drive the air compressor, and on the other hand an embodiment is advantageous having the form of a steam circuit that is closed and is separate from the exhaust gas flow, such that the steam does not mix with the exhaust gas and flows over a steam turbine wheel provided on the same shaft as an exhaust gas turbine wheel to which only exhaust gas flows. The exhaust passage and steam circuit are thus separate from one another. It can also be provided to introduce the steam, in a flow adjacent to the exhaust gas flow, into an exhaust gas turbine having a dual flow to the turbine wheel.

The steam accumulator is provided for the storage of the generated steam. After the generation of the steam by the steam generator, the steam is thus not supplied immediately to the exhaust gas turbocharger, but rather is intermediately stored in the steam accumulator. The steam stored in the steam accumulator may be a saturated steam, so that the steam accumulator can also be designated a saturated steam accumulator or saturated steam boiler. In the steam accumulator, the steam is only intermediately stored; no removal of the energy contained in the steam takes place. The storage capacity of the steam accumulator enables, without mechanical additional aggregates having rotating elements and additional moments of inertia, a very agile response of the exhaust gas turbocharger even at low rotational speeds of the internal combustion engine and at low exhaust gas and charge air mass flows of the internal combustion engine. In the steam accumulator, a saturation steam pressure is established as a function of the temperature of the steam fed in. The steam accumulator can be continuously charged with steam as long as the internal combustion engine is operated with sufficiently high exhaust gas temperatures. Advantageously, the walls of the steam accumulator are thermally insulated. Its storage capacity may be large enough to be able to keep in reserve sufficient steam for the rapid acceleration of the drive turbine even during longer operating phases of the internal combustion engine with low power output and low exhaust gas temperature and low exhaust gas mass flow. This capacity in turn results in the desired agile response of the exhaust gas turbocharger, or its air compressor, even at low rotational speeds of the internal combustion engine and low exhaust gas and charge air mass flows. In addition, it can be provided to supply at least a part of the steam taken from the steam accumulator, in particular saturated steam, immediately to the exhaust gas turbocharger.

The exemplary embodiments and/or exemplary methods of the present invention provides that a heat exchanger, in particular situated downstream from the exhaust gas turbocharger, is provided in order to draw the thermal energy. The heat exchanger is used to draw thermal energy from the exhaust gas and supply it to the steam generator. It is advantageous to situate the heat exchanger such that it can be used to draw residual energy still contained in the exhaust gas after this gas has flowed through the exhaust gas turbocharger. The heat exchanger and steam generator can also be realized in an integrated construction.

In the exemplary embodiments and/or exemplary methods of the present invention, it is provided that at least a part of the steam is merged with the exhaust gas, upstream from the exhaust gas turbocharger or in the exhaust gas turbocharger. As stated above, the exhaust passage and the steam circuit can coincide at least in regions. In such a region, the steam is merged with the exhaust gas, for example in a common conduit. Via the common conduit, the mixture of exhaust gas and steam can be supplied together to the exhaust gas turbocharger, or to its drive turbine. Here the turbine wheel is driven by one flow, through only one nozzle, of the exhaust gas/steam mixture. However, it can also be provided for the merging of steam and exhaust gas to take place not until inside the exhaust gas turbocharger, but which may be before or in the drive turbine. The merging before or in the exhaust gas turbocharger on the one hand increases the mass flow flowing through the exhaust gas turbocharger while simultaneously lowering the temperature of the exhaust gas, as long as the steam temperature does not exceed the exhaust gas temperature, which is the case in particular in the full load range of gasoline and diesel engines, so that the thermal load on the exhaust gas turbocharger can be reduced.

In the exemplary embodiments and/or exemplary methods of the present invention, a condenser and/or separator for recuperating the fluid from the exhaust gas is provided downstream from the exhaust gas turbocharger. If the steam is merged with the exhaust gas, it makes sense for this steam not to be emitted together with the exhaust gas from the driving device into the environment surrounding the driving device.

Rather, the fluid should be recuperated from the exhaust gas so that it can be reused. The separator and/or condenser are provided for this purpose. Using them, the fluid, or the evaporated fluid, is deposited from the exhaust gas so that it can be supplied again to the steam circuit. As a result, it is necessary to carry only a comparatively small supply of the fluid with the driving device, and only unavoidable fluid losses need be compensated from time to time.

In the exemplary embodiments and/or exemplary methods of the present invention, it is provided that the exhaust gas turbocharger has at least one exhaust gas flow and at least one steam flow that are separated from one another in terms of flow. Thus, in such a specific embodiment it is provided that the steam is not merged with the exhaust gas, but rather is conducted separately through the exhaust gas turbocharger. The at least one exhaust gas flow and the at least one steam flow, in each of which there may be situated a turbine wheel, are provided for this purpose. The exhaust gas flows through the exhaust gas flow, and the steam flows through the steam flow. The turbine wheels allocated to the flows are connected to one another by a common shaft that is simultaneously connected to the air compressor. In these specific embodiments, the exhaust passage and the steam circuit are completely separated from one another, so that the steam does not at any time come into contact with the exhaust gas. For this reason, no additional separator or condenser is necessary.

Alternatively, however, it is also possible for the exhaust gas to be merged with the steam even in a multi-flow embodiment.

In this case, each flow can be matched to the respective pressure or respective temperature of the exhaust gas or of the steam. In this specific embodiment, the steam and the exhaust gas flow are for example routed separately from one another up to immediately before a turbine wheel of the drive turbine, and flow into the exhaust gas turbocharger independently of one another through, respectively, a steam nozzle and an exhaust gas nozzle (hot gas nozzle), without mixing with one another before driving. The steam nozzle and the exhaust gas nozzle can advantageously be designed so as to be adapted independently of one another to the mechanical flow conditions and thermal conditions in the exhaust gas and in the steam.

In the exemplary embodiments and/or exemplary methods of the present invention, it is provided that the exhaust gas flow and the steam flow are provided in a housing of the exhaust gas turbocharger. Thus, a common housing is fashioned that may accommodate all flows of the exhaust gas turbocharger. Alternatively, however, each flow could have its own housing, and the turbine wheels assigned to the flows could be connected to one another only via a common shaft. In a specific embodiment, a two-part drive turbine can be provided. For this purpose, the housing has at least one exhaust gas flow chamber containing an exhaust gas turbine wheel, and a steam flow chamber separate therefrom containing a steam turbine wheel. Independently of one another, the steam and the exhaust gas act on the two-part drive turbine without mixing with one another, and flow out of this turbine separately from one another. It is also possible to provide a plurality of steam flows, so that the exhaust gas turbocharger is acted on by a plurality of steam flows. Here, a saturated steam flow and a superheated steam flow can be provided that are supplied to the exhaust gas turbocharger in adjacent flows.

In the exemplary embodiments and/or exemplary methods of the present invention, it is provided that the drive turbine of the exhaust gas turbocharger has at least one exhaust gas turbine wheel and at least one steam turbine wheel, the steam turbine wheel and the exhaust gas turbine wheel being provided on a common shaft. The exhaust gas turbine wheel may be allocated to the exhaust gas flow, and the steam turbine wheel may be assigned to the steam flow. The air compressor of the exhaust gas turbocharger is driven via the common shaft.

In the exemplary embodiments and/or exemplary methods of the present invention, a superheater is provided, situated in the flow between the steam generator and/or the steam accumulator and the exhaust gas turbocharger. Steam from the steam generator and/or the steam accumulator flows through the superheater. The superheater is situated upstream from the exhaust gas turbocharger. Here, the steam, present in particular as saturated steam, is further heated. The steam present after the superheater can thus be designated superheated steam. This superheated steam is subsequently supplied to the exhaust gas turbocharger. Here it can also be provided that a portion of the steam supplied to the exhaust gas turbocharger comes from the steam accumulator or the steam boiler, and a further portion comes from the superheater. These portions may be adjusted in a controlled and/or regulated fashion. In this way, the action of the steam on the exhaust gas turbocharger can advantageously be adapted to the exhaust gas temperature, as well as to the operating state and the desired power output of the internal combustion engine. In the closed steam circuit, the superheated and/or saturated steam flow acting on the above-described steam turbine wheel can be supplied to the exhaust gas turbocharger in one flow or in two flows.

In the exemplary embodiments and/or exemplary methods of the present invention, it is provided that thermal energy can act on the superheater from an additional high-temperature heat exchanger, in particular situated upstream from the turbocharger. Like the heat exchanger, the high-temperature heat exchanger draws thermal energy from the exhaust gas. The expression “high-temperature heat exchanger” merely signifies that the temperature range in which the high-temperature heat exchanger operates is higher than that of the heat exchanger. For this purpose, it is advantageous for the exhaust gas turbocharger to be situated at a location in the exhaust passage at which the exhaust gas still has a comparatively high temperature.

In the exemplary embodiments and/or exemplary methods of the present invention, it is provided that the steam accumulator is situated in an exhaust gas pipe or surrounds this pipe. The exhaust gas pipe is part of the exhaust passage. The exhaust gas pipe essentially designates all (pipe) conduits through which exhaust gas flows. In order to prevent the steam stored in the steam accumulator from cooling and thus condensing to fluid, the steam accumulator may be constantly heated. This is achieved by situating the steam accumulator in the area of the exhaust gas pipe. Here the accumulator may be situated in the exhaust gas pipe or surrounding the exhaust gas pipe. In the first case, care must be taken that the steam accumulator presents as little resistance as possible to the flow of the exhaust gas flowing in the exhaust gas pipe. For this purpose, the steam accumulator can be designed so as to be optimized in terms of flow. If the steam accumulator surrounds the exhaust gas pipe, then it makes sense for this pipe to be made, at least in this region, of material having good heat conductivity. The exhaust gas pipe can also include an exhaust manifold.

In the exemplary embodiments and/or exemplary methods of the present invention, a heat accumulator is provided that is allocated to the steam accumulator. The heat accumulator can for example include a latent heat storage medium whose aggregate state changes from solid to liquid in the range of the desired steam temperature. In this way, the temperature of the steam present in the steam accumulator can be held at the desired temperature even if only a small amount of thermal energy can be drawn from the exhaust gas, or if an excess of thermal energy is present.

The exemplary embodiments and/or exemplary methods of the present invention provides that at least one exhaust gas post-treatment device is provided downstream and/or upstream from the steam generator. The exhaust gas post-treatment device is for example a catalytic converter or a filter.

In the following, the exemplary embodiments and/or exemplary methods of the present invention are explained in more detail on the basis of exemplary embodiments shown in the drawing, without thereby limiting the present invention.

### BRIEF DESCRIPTION OF THE DRAWINGS

FIG. 1 shows a schematic representation of a driving device in a first specific embodiment, in which a steam circuit runs in common in some regions with an exhaust passage of an internal combustion engine, and a heat exchanger is situated downstream from an exhaust gas post-treatment device.

FIG. 2 shows the driving device known from FIG. 1, but here the heat exchanger is situated upstream from the exhaust gas post-treatment device.

FIG. 3 shows a second specific embodiment of the driving device in which the steam circuit runs separately from the exhaust passage, so that the steam circuit is closed and is fashioned separately from the exhaust passage.

FIG. 4 shows the driving device known from FIG. 3, in which a fluid supply line to a steam accumulator is provided.

FIG. 5a shows the steam accumulator in a first specific embodiment.

FIG. 5b shows the steam accumulator in a second specific embodiment.

### DETAILED DESCRIPTION

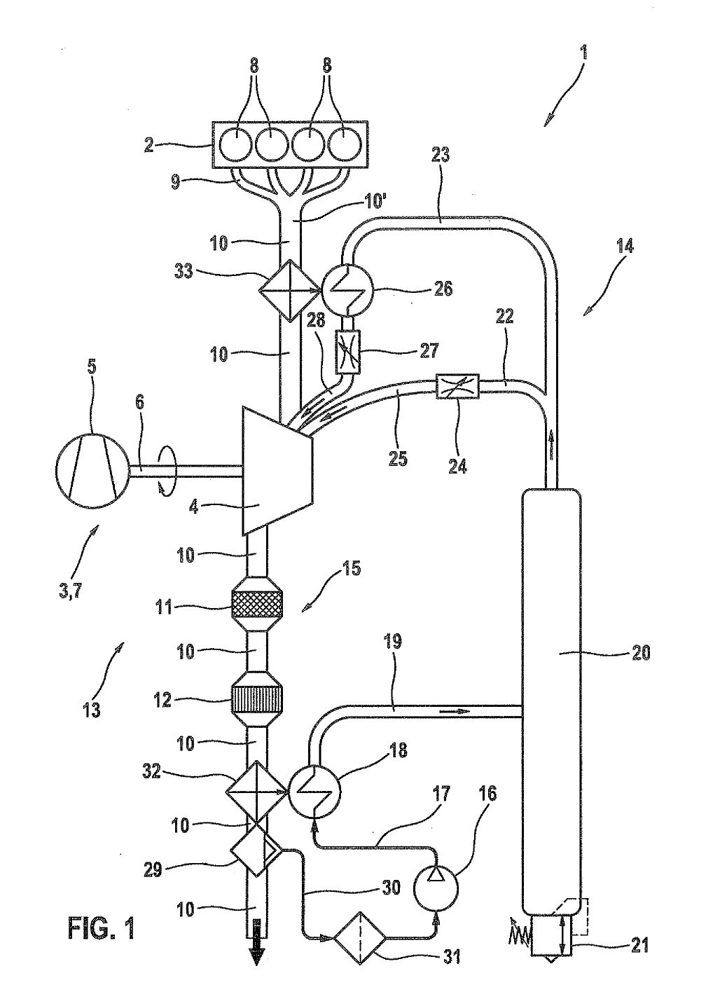

FIG. 1 shows a first specific embodiment of a driving device 1 having an internal combustion engine 2 and a charging device 3. Charging device 3 has a turbine part 4 that has at least one drive turbine and a compressor part 5, the turbine part and the compressor part being operationally connected via a shaft 6. Charging device 3 is an exhaust gas turbocharger 7 through whose turbine part 4 there flows at least exhaust gas of internal combustion engine 2. Using a turbine wheel provided in turbine part 4, flow energy of the exhaust gas is converted into mechanical energy and is made available to compressor part 5 via shaft 6. Compressor part 5 is in turn used to compress air, in particular drawn from the surrounding environment of driving device 1, thus bringing it to a higher pressure. The compressed air is then supplied to internal combustion engine 2. The resulting exhaust gases coming from cylinders 8 of internal combustion engine 2 are merged by an exhaust manifold 9 and are conducted away in an exhaust gas pipe 10. Exhaust manifold 9 is for example fashioned as a header. Connected thereto is an exhaust collector pipe 10′ that is a component of exhaust pipe 10. Of course, internal combustion engine 2 can also have a plurality of cylinder banks; in this case, both a plurality of exhaust manifolds 9 and a plurality of exhaust collector pipes 10′ or exhaust pipes 10 are provided. Through exhaust pipe 10, the exhaust gas flows at least to turbine part 4 of charging device 3.

Downstream from charging device 3, or exhaust gas turbocharger 7, there are situated a first exhaust gas post-treatment device 11 and a second exhaust gas post-treatment device 12, connected in series. Second exhaust gas post-treatment device 12 is an SCR catalytic converter. Previously described parts that conduct exhaust gas, such as exhaust pipe 10, form an exhaust passage 13 through which the exhaust gas from internal combustion engine 2 is conducted away.

First exhaust gas post-treatment device 11 is made up, for example in a diesel engine, of an HC oxidation catalytic converter (DOC) and a diesel particle filter (DPF), while in a gasoline engine it is as a rule a 3-way catalytic converter. Second exhaust gas post-treatment device 12 can, in a diesel engine, be a reduction catalytic converter having a preposed urea dosing device or injector (SCR), and in a stratified-charged gasoline engine, in particular having direct injection, it can be an NOₓ storage catalytic converter (NSC). Second exhaust gas post-treatment device 12 standardly operates at lower temperatures than does first exhaust gas post-treatment device 11, and is therefore situated downstream therefrom.

FIG. 1 also shows a steam circuit 14. In this circuit, steam is generated that can also be supplied to exhaust gas turbocharger 7. Here, exhaust passage 13 and steam circuit 14 have a common region 15 through which the generated steam flows together with the exhaust gas. Steam circuit 14 first has a fluid conveyor device 16, for example a pump. This device is connected via a fluid line 17 to a steam generator 18, and can supply fluid thereto. Steam generator 18 is provided for the evaporation of the supplied fluid. Following steam generator 18, the steam thus generated flows via a steam line 19 to a steam accumulator 20 in which the steam is stored. Steam accumulator 20 has a steam valve 21 by which steam can be released from steam accumulator 20. In this way, the steam pressure in steam accumulator 20 can be regulated or limited.

Steam accumulator 20 is connected to exhaust gas turbocharger 7 via a first supply line 22 and a second supply line 23. Thus, via supply lines 22 and 23 steam can be introduced into exhaust gas turbocharger 7, or its turbine part 4. Here, the steam can already be merged with the exhaust gas upstream from exhaust gas turbocharger 7, or, as shown in FIG. 1, can be merged therewith in but not before exhaust gas turbocharger 7. A cross-sectional displacement element 24, for example an electrically adjustable throttle valve, is situated in first supply line 22. Using this element, the quantity of steam introduced into exhaust gas turbocharger 7 from steam accumulator 20 can be adjusted in a controlled and/or regulated fashion. Because so-called saturated steam is present in steam accumulator 20, first supply line 22 can also be designated saturated steam line 25. In second supply line 23 there is situated first a superheater 26 and, downstream therefrom, another cross-sectional displacement element 27. Using superheater 26, steam, or saturated steam, can be superheated, so that superheated steam is present after superheater 26. Using cross-sectional displacement element 27, which for example can also be an electrically adjustable throttle valve, the quantity of superheated steam supplied to exhaust gas turbocharger 7 through a superheated steam line 28 can be adjusted in a controlled or regulated fashion.

The steam introduced into the exhaust gas via saturated steam line 25, or superheated steam line 28, flows through exhaust gas turbocharger 7, exhaust gas post-treatment devices 11 and 12, and a separator 29. In separator 29, the steam, or fluid, is removed from the mixture of exhaust gas and steam, and is supplied via a fluid line 30 to a fluid cleaning device 31 that for example has a filter. In fluid cleaning device 31, the fluid is freed of impurities, for example dirt particles, that it has received from the exhaust gas. Fluid cleaning device 31 can for example also have a deacidification device. The fluid cleaned by fluid cleaning device 31 is subsequently supplied again to fluid conveying device 16. Alternatively, it can also be conveyed to a supply container (not shown) in which it is stored. From the supply container or from fluid cleaning device 31, the fluid can again be supplied to steam generator 18 by fluid conveyor device 16. Steam generator 18 is operated for the evaporation of the fluid, using thermal energy taken from the exhaust gas of internal combustion engine 2 by a heat exchanger 32. Heat exchanger 32 is provided in the exhaust passage, or in exhaust pipe 10. Superheater 26 is supplied with thermal energy by a high-temperature heat exchanger 33. Heat exchanger 32 is provided downstream from exhaust gas post-treatment devices 11 and 12, and high-temperature heat exchanger 33 is provided upstream (relative in each case to the exhaust gas) from exhaust gas turbocharger 7.

A portion of the saturated steam is thus conducted from steam accumulator 20 into superheater 26, which is supplied by high-temperature heat exchanger 33 with thermal energy from the exhaust gas. Via cross-sectional displacement element 27, the superheated steam thus generated reaches exhaust gas turbocharger 7. Here it is advantageous if the superheated steam flows into turbine part 4 through a separate inlet opening, in an adjacent flow. An advantageous embodiment of turbine part 4 thus includes a triple flow to a turbine wheel (not shown), enabling inlet nozzles to be designed so as to be adapted to differing pressures and/or temperatures of the exhaust gas or of the saturated and/or superheated steam. Such a multiflow action on turbine part 4 prevents a flow of the steam going out from exhaust gas turbocharger 7 in the direction of internal combustion engine 2. A return flow of this sort could cause a turbulent flow to the turbine, which would be disadvantageous for the efficiency of the exhaust gas turbocharger. The distribution of the steam from steam accumulator 20 to superheated steam line 28, or saturated steam line 25, is adjusted in continuous fashion by cross-sectional displacement elements 24 and 27, which are for example throttle valves. The thermal energy taken from the exhaust gas by heat exchangers 32 and 33 can also be used for further purposes in addition to the evaporation or superheating of the fluid. In a motor vehicle, for example, the energy can be emitted to an undercarriage air flow, or, via corresponding preheating devices, to a passenger compartment that is to be heated. It is also conceivable to make the thermal energy available to a cooling water or oil circuit of internal combustion engine 2 so that the engine can be heated faster.

Driving device 1 shown in FIG. 1, in which heat exchanger 32 is situated downstream from exhaust gas post-treatment devices 11 and 12, can standardly be used if internal combustion engine 2 is a gasoline engine. For this engine, it is necessary to maintain the temperature of second exhaust gas post-treatment device 12, which is for example the NOₓ storage catalytic converter, at a temperature greater than 300° C.

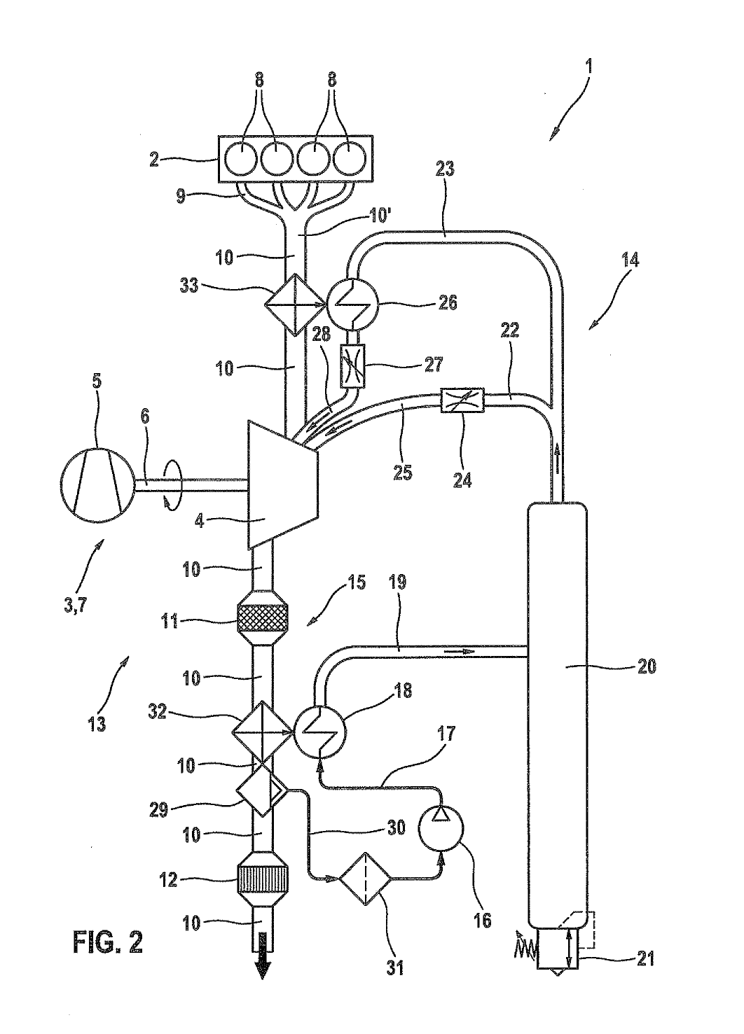

In contrast, FIG. 2 shows the exhaust gas post-treatment device 1 known from FIG. 1 in a configuration in which it can be used if internal combustion engine 2 is a diesel engine. In this case, it can make sense to situate heat exchanger 32 upstream from second exhaust gas post-treatment device 12 in order to be able to supply steam generator 18 with a sufficient quantity of thermal energy. In contrast, the SCR catalytic converter often provided as exhaust gas post-treatment device 12 is also effective at temperatures of about 170° C., and can therefore unproblematically be situated downstream from heat exchanger 32.

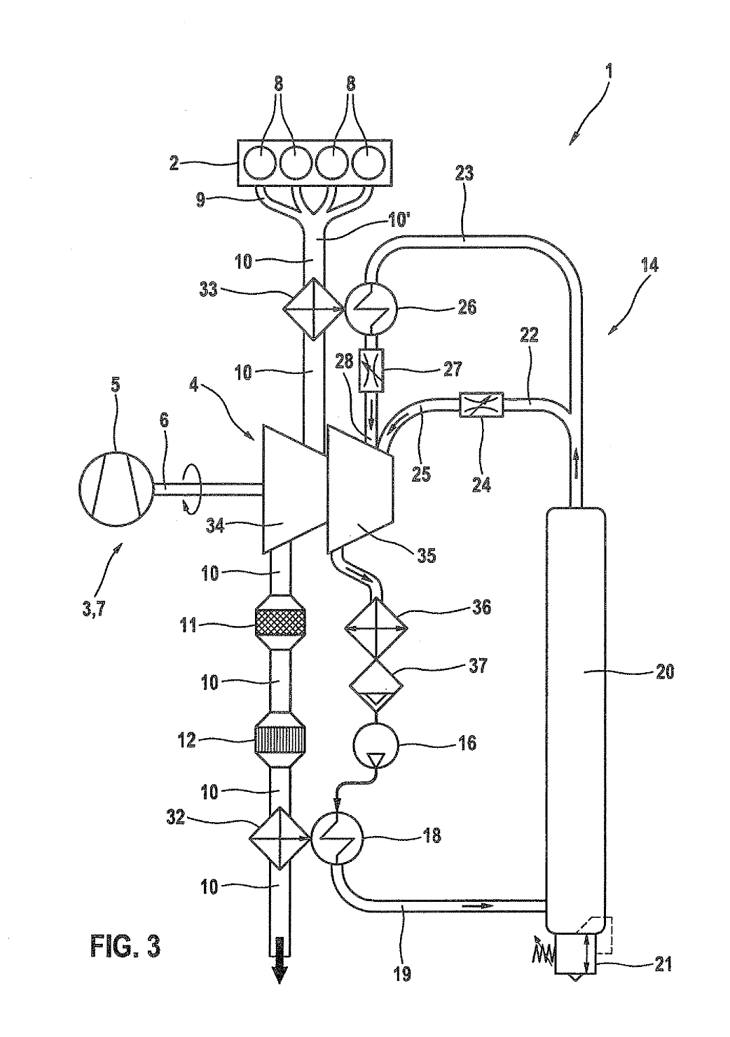

FIG. 3 shows a second specific embodiment of driving device 1. This specific embodiment differs from the first specific embodiment shown in FIG. 1 with regard to the design of steam circuit 14 and of exhaust gas turbocharger 7. Further statements relating to FIGS. 1 and 2 are therefore also valid for the specific embodiments described below. In order to realize steam circuit 14 that is provided in this specific embodiment and is separate from exhaust passage 13, first of all turbine part 4 has a multiflow (here: two-flow) construction. It has an exhaust flow 34 and two steam flows 35 (not shown separately). Exhaust flow 34 is connected to exhaust pipe 10, and only exhaust gas flows through it. In contrast, only steam flows through steam flows 35; one of these steam flows 35 can be fed by saturated steam line 25, and the other can be fed by superheated steam line 28. Flows 34 and 35 are thus completely separated from one another in terms of flow. A turbine wheel, driven by the exhaust gas or by the steam, is provided both in exhaust gas flow 34 and in each of steam flows 35. The turbine wheels are connected to compressor part 5 via a common shaft 6. Shaft 6 is thus drivable both by exhaust gas flow 34 and by steam flow 35.

Downstream from steam flows 35 of exhaust gas turbocharger 7, a condenser 36 is provided by which the steam flowing out of steam flows 35 is condensed so that the fluid is present in condenser 36 and can be brought out therefrom. The fluid is stored in a supply container 37 from which it can be supplied to steam generator 18 by fluid conveyor device 16. As described above on the basis of FIG. 1, steam generator 18 is supplied with thermal energy by heat exchanger 32, which is situated in exhaust passage 13, and is used to evaporate the fluid. The produced steam is supplied to steam accumulator 20 via steam line 19, from which it can be supplied to exhaust gas turbocharger 7 via supply lines 22 and 23, or saturated steam supply line 25 and superheated steam supply line 28. Inlet nozzles and turbine wheels of steam flows 35 are each optimized to the properties of the saturated steam or superheated steam. The inlet openings of steam flows 35 can be designed as de Laval nozzles. A multiflow, in particular two-flow, realization of steam flows 35 prevents dissipation due to turbulent mixing of superheated and saturated steam in the turbine inlet flow. Exhaust gas flow 34 and steam flows 35 may be situated in a common housing (not shown). In a powerful gasoline engine, in which a high degree of thermal exhaust gas energy is available, a de Laval turbine wheel can be used in exhaust gas turbocharger 7. As can be seen on the basis of FIG. 2, heat exchanger 32 can also be situated upstream at least from second exhaust gas post-treatment device 12. If, as in the present case, steam circuit 14 is separate from exhaust passage 13, a Clausius-Rankine steam process takes place in steam circuit 14.

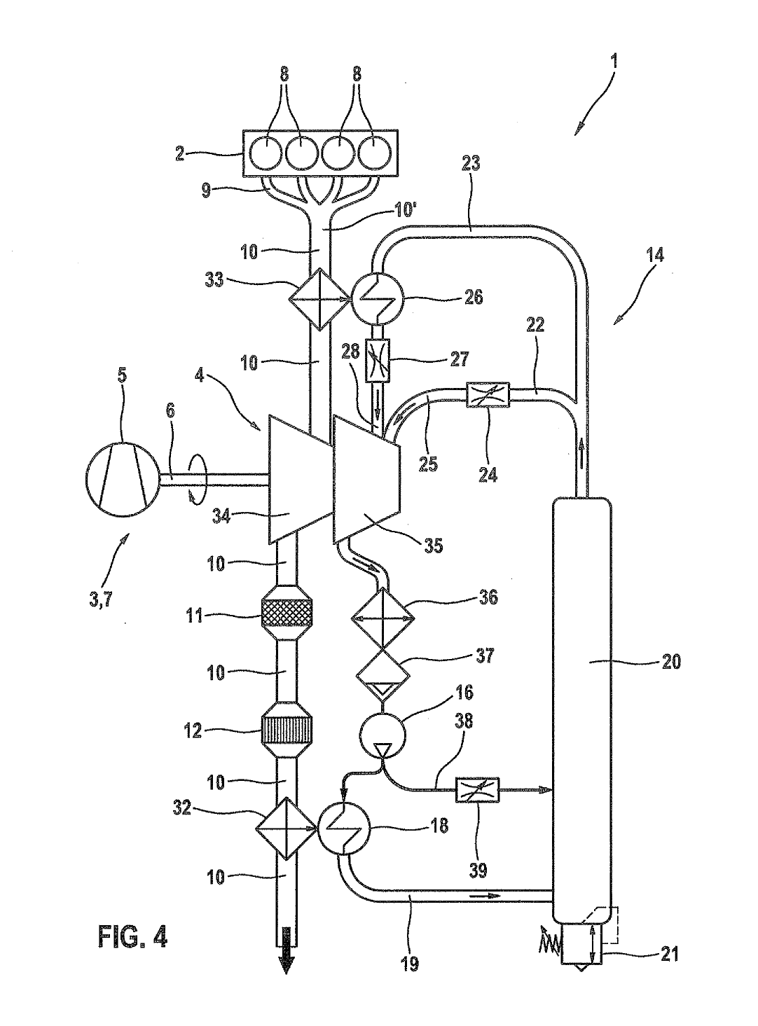

In gasoline engines in particular, in the full load range of internal combustion engine 2 there occur high exhaust gas temperatures, above 1000° C., causing thermal overloading of exhaust gas turbocharger 7 and exhaust gas post-treatment devices 11 and 12. In conventional driving device is 1 this is countered by a full-load enrichment of the fuel-air mixture, causing a reduction in the exhaust gas temperatures relative to a stoichiometric mixture formation. Another possibility for reducing the temperature is shown in FIG. 4. This Figure shows driving device 1 known from FIG. 3. Here, however, it is additionally provided to introduce, via a fresh fluid line 38, a quantity of unevaporated fluid into steam accumulator 20 that can be adjusted using a cross-sectional displacement element 39. The fluid may be sprayed or atomized when being introduced into steam accumulator 20. In this way, the saturated steam contained in steam accumulator 20 can be humidified, so that wet steam is present.

This wet steam can flow immediately from steam accumulator 20 into exhaust gas turbocharger 7 via first supply line 22, or saturated steam line 25. The wet steam is superheated in exhaust gas turbocharger 7, thus cooling it. The quantity of heat taken from the wet steam corresponds substantially to the evaporation enthalpy of the contained liquid phase, i.e. of the fluid introduced into steam accumulator 20 via fresh fluid line 38. It is still more advantageous if fresh fluid line 38 and cross-sectional displacement device 39 are provided in driving device 1 according to FIGS. 1 and 2. Here, the exhaust gas temperature can be lowered directly by the introduced fluid, so that the temperature load on exhaust gas turbocharger 7, or exhaust gas post-treatment devices 11 and 12, is reduced.

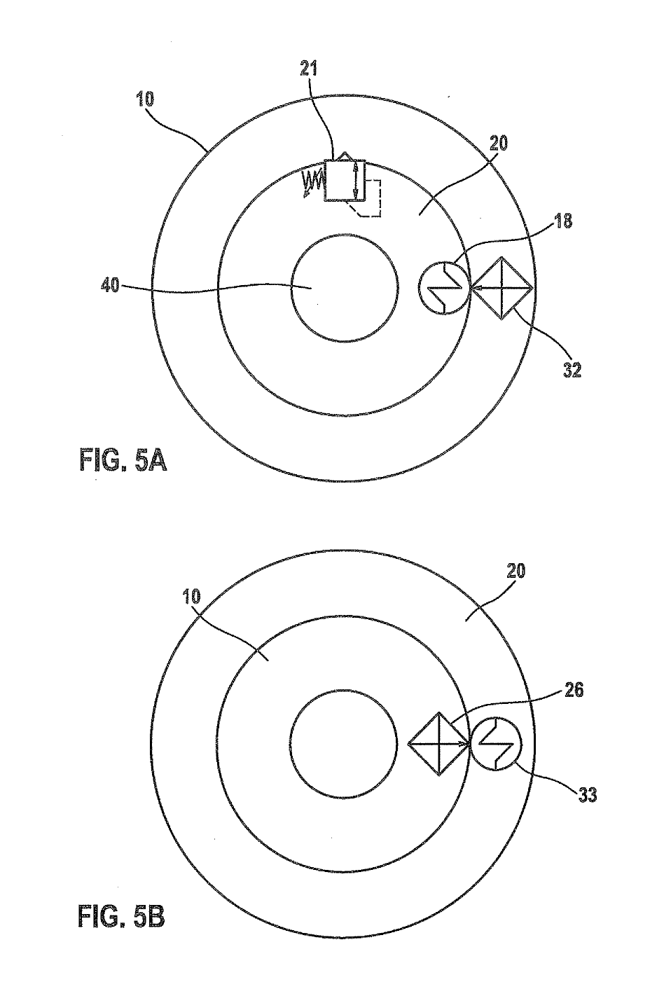

FIGS. 5a and 5b each show a specific embodiment of steam accumulator 20. Steam accumulator 20 shown in FIG. 5a has a tubular construction and is situated in exhaust pipe 10 together with heat exchanger 32 and steam generator 18. This means that exhaust gas flows both through steam accumulator 20 and through heat exchanger 32. In this way, heat losses of steam accumulator 20 are reduced. Likewise, no additional external installation space is taken up in the area of a vehicle undercarriage. A heat accumulator 40, in particular including a latent heat storage medium, can be provided in steam accumulator 20. In the range of the desired saturated steam temperature, the aggregate state of this latent heat storage medium changes from solid to liquid. Using steam valve 21, saturated steam can be released from steam accumulator 20 into exhaust pipe 10.

FIG. 5b shows another specific embodiment of steam accumulator 20. Here, steam accumulator 20 surrounds exhaust pipe 10, which may be in an area close to the engine. Here it is also possible that, alternatively or in addition, steam accumulator 20 also surrounds exhaust manifold 9 at least in some regions. For this purpose, steam accumulator 20, in connection with high-temperature heat exchanger 33 and superheater 26, is advantageously fashioned as a two-walled cast part having a high heat storage capacity. In addition, the cast part can provide a mounting flange for the exhaust gas turbine and a tap for an exhaust gas return line, in particular a high-pressure exhaust gas return line. Heat accumulator 40 (not shown) can be situated in a double wall of the (saturated) steam accumulator. Such a specific embodiment of steam accumulator 20 results in a substantial reduction in the undesired radiation of heat into an engine chamber of internal combustion engine 2. It uses the high-temperature waste heat of exhaust manifold 9 to superheat the saturated steam and to quickly bring about operational readiness during warming up of internal combustion engine 2. As also seen above in the case of steam accumulator 20 shown in FIG. 5a, in this specific embodiment no additional space is taken up in the region of the vehicle undercarriage.

In the above-described specific embodiments of driving device 1, advantageous control or regulation strategies, or methods for operating driving device 1, are provided. Immediately after a cold start of internal combustion engine 2, a rapid increase in the output of the internal combustion engine is not advisable; for this reason, an electronic control device of internal combustion engine 2 will therefore limit or prevent the action of steam on exhaust gas turbocharger 70 for rapid acceleration and increase of the charge pressure until the mechanics, cooling water, and lubricant oil of internal combustion engine 2 have warmed up sufficiently, and internal combustion engine 2 can handle the sudden increase of output without damage. Steam pressure and steam mass are built up in steam accumulator 20 until the release of the full steam charge by the control device of internal combustion engine 2, because the operation of internal combustion engine 2 makes available an already-sufficient exhaust gas temperature and quantity of waste heat or thermal energy.

Using described driving device 1, a rapid warm start of internal combustion engine 2 can also be achieved in “start-stop” operation. Steam accumulator 20 maintains the pressure and temperature of the steam even during longer operational pauses of internal combustion engine 2, because the evaporation of the fluid, and thus the supply of steam to steam accumulator 20, operates continuously as long as internal combustion engine 2 is running. This holds even when no steam is acting on exhaust gas turbocharger 7. In this way, sufficient steam at high pressure is continuously available in steam accumulator 20 to bring about a very rapid increase of the charge pressure and thus an agile deployment of power, independent of the operating state of internal combustion engine 2 and of exhaust gas turbocharger 7. Steam accumulator 20 as shown in FIGS. 5a and 5b, which may be provided with heat accumulator 40 for this purpose, is in particular suitable for this. The immediate operational readiness of the action of steam on exhaust gas turbocharger 7 ensures a reliable fast start of internal combustion engine 2 because the rapid increase in charge pressure is used to provide a good cylinder filling and a reduction of intake work during the start phase without consuming mechanical or electrical power that would have to be provided by internal combustion engine 2.

Likewise, an exhaust gas post-treatment and interval operation can be achieved in particular in the specific embodiments described on the basis of FIGS. 1 and 2, i.e. those having an open steam circuit. During a regeneration of exhaust gas post-treatment devices 11 and 12, in particular of a diesel particle filter (DPF), the action of steam on exhaust gas turbocharger 7 is prevented, as it is during a warm-up phase of the pre-catalytic converter of warm-running gasoline engines, because in these operating phases higher exhaust gas temperatures are temporarily desirable in order to heat exhaust gas post-treatment devices 11 and 12. The supply of superheated steam to exhaust gas turbocharger 7 itself would decrease the exhaust gas temperature too much. During these phases, therefore, cross-sectional displacement elements 24 and 27 are closed. The thermal exhaust gas energy that is increased by later fuel post-injections (diesel engine) or later ignitions (gasoline engine) are however also used by heat exchanger 32 and steam generator 18 in order to supply steam to steam accumulator 20. In contrast, for the specific embodiment of driving device 1 described on the basis of FIG. 3, in which exhaust passage 13 and steam circuit 14 are separate, the action of steam on exhaust gas turbocharger 7 must not be interrupted, even if exhaust gas temperatures that are as high as possible of the internal combustion engine are to be achieved during a regeneration of the diesel particle filter or heating of the 3-way catalytic converter.

Using described driving device 1, it is also possible to achieve an intervallic action for the compensation of pressure fluctuations in exhaust gas turbochargers 7 having a multiple input flow. For slow and medium-fast running diesel engines in stationary aggregates, trucks, and ships, the impact loading, which is advantageous in terms of flow mechanics, may be used, supplying a high gas mass flow and charge pressure even in a lower rotational speed range of internal combustion engine 2. In order to compensate the pronounced pressure fluctuations, in phases of high exhaust gas pressure very damp wet steam is introduced into exhaust gas turbocharger 7 in combination with a temporally high-resolution exhaust gas pressure sensor (not shown) and an electronic control device via cross-sectional displacement element 24, which in this case is fashioned as a fast-switching throttle valve. The evaporation of the liquid phase, i.e. of the liquid contained in the steam, lowers the temperature and pressure of the gas flow in exhaust gas turbocharger 7. In contrast, during phases of low steam pressure cross-sectional displacement element 24 is closed, and via cross-sectional displacement element 27 dry superheated steam from superheater 26 is introduced in order to momentarily increase the steam pressure at the inlet of exhaust gas turbocharger 7.

1-12. (canceled)

13. A driving device, comprising:
a charging device for increasing a pressure and a mass flow of combustion air of an internal combustion engine;
a steam generator for evaporating a fluid using thermal energy drawn from exhaust gas of the internal combustion engine,
wherein the steam generator is connected to a steam accumulator,
wherein the charging device includes an exhaust gas turbocharger whose drive turbine can be acted on at least partly both by exhaust gas and also by steam from the steam accumulator, and
wherein at least one of the steam pressure and the steam mass flow of the steam supplied to the exhaust gas turbocharger is at least one of regulatable and controllable.

14. The driving device of claim 13, wherein in order to draw the thermal energy a heat exchanger (32) is provided, in particular situated downstream from the exhaust gas turbocharger (7).

15. The driving device of claim 13, wherein at least a part of the steam is merged with the exhaust gas downstream from the exhaust gas turbocharger or in the exhaust gas turbocharger.

16. The driving device of claim 13, wherein there is at least one of a condenser and a separator, situated downstream from the exhaust gas turbocharger, for recuperating the fluid from the exhaust gas.

17. The driving device of claim 13, wherein the exhaust gas turbocharger has at least one exhaust gas flow and at least one steam flow that are realized separately from one another in terms of flow mechanics.

18. The driving device of claim 13, wherein the exhaust gas flow and the steam flow are provided in a housing of the exhaust gas turbocharger.

19. The driving device of claim 13, wherein the drive turbine of the exhaust gas turbocharger has at least one of at least one exhaust gas turbine wheel and at least one steam turbine wheel, and wherein the steam turbine wheel and the exhaust gas turbine wheel are provided on a common shaft.

20. The driving device of claim 13, wherein there is a superheater in the flow between at least one of the steam generator and the steam accumulator and the exhaust gas turbocharger.

21. The driving device of claim 13, wherein the superheater can be charged with thermal energy by an additional, high-temperature heat exchanger, which is situated upstream from the exhaust gas turbocharger.

22. The driving device of claim 13, wherein the steam accumulator is situated in an exhaust pipe or surrounds this pipe.

23. The driving device of claim 13, wherein a heat accumulator is allocated to the steam accumulator.

24. The driving device of claim 13, wherein there is at least one exhaust gas post-treatment device at least one of downstream and upstream from the steam generator.
